(19) United States
(12) Patent Application Publication
(10) Pub. No.: US 2008/0189873 A1
(43) Pub. Date: Aug. 14, 2008

(54) Method for Treating a Laundry Item

(75) Inventors: Mattia De Dominicis, Montvale, NJ (US); Lucia Rossi, Mira (IT); Roberto Vanin, Mira (IT); Giorgio Franzolin, Mira (IT)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., Hoofddorp (NL)

(21) Appl. No.: 11/910,858

(22) PCT Filed: Apr. 18, 2006
(86) PCT No.: PCT/GB2006/001395

§ 371 Date: Nov. 12, 2007

(30) Foreign Application Priority Data
Apr. 15, 2005 (EP) 05252345.3

(51) Int. Cl. C11D 11/00; D06L 1/00; C11D 3/02; C11D 3/16

(52) U.S. Cl. 8/142; 8/137; 510/297

(57) ABSTRACT

A process for treating a laundry item, which comprises
contacting the laundry item with a cleaning composition in the form of a solid comprising an insoluble active agent that is capable of binding soil and free dyes, such that soil on the laundry item is bound to the insoluble active agent, and
removing the composition from the laundry item, optionally in the absence of water.

The present invention relates to a process for treating a laundry item. The present invention also relates to a cleaning product for laundry.

Laundry cleaning products are extremely well known. Usually a composition in the form of a liquid or powder is added to a laundry washing machine, either directly to the drum or via a dispenser, and washing is carried out using an appropriate selection from a number of pre-programmed cycles. Accurate dosing may be a problem, particularly when consumers do not read or follow the dosing instructions. Recently products in the form of laundry compositions packaged in a film of water-soluble polymer have become available. However, alternative methods of presentation of unit-dosed products are desired. Furthermore, there may be a preconception in the minds of some consumers that the polymer may not dissolve fully or that the polymer might dissolve before the product is added to the wash. Additionally the product is perceived as being fragile, and it lacks versatility in use.

Compositions for pretreating a laundry item, for example to remove a stain or to assist in stain removal, are also known. Such compositions are, for example, in the form of a liquid composition which may be applied directly to the laundry item, for example, by spraying. Typically, however, such compositions need to be rinsed off with water after use, for example, by hand or in a laundry washing machine.

We have now found that certain active agents in the form of a solid (preferably in the form of a powder) that can be used to remove soils from laundry, which do not need to be rinsed off with water after use, but can be easily brushed off by the user.

Accordingly, a first aspect of the present invention provides a method for treating a laundry item, which comprises
contacting the laundry item with a cleaning composition in the form of a solid comprising an insoluble active agent that is capable of binding soil, such that soil on the laundry item is bound to the insoluble active agent, and
removing the composition from the laundry item, optionally in the absence of water.

Preferably, the laundry item is contacted with the cleaning composition when it is freshly soiled. Thus, the cleaning composition may be applied to the laundry item within 30 minutes of the soil occurring, preferably within 10 minutes, for example within 1 minute. If desired, the laundry item may be wetted or moistened to assist the cleaning composition to contact the stain.

The composition may then be left on the soiled area for sufficient time to allow the insoluble active agent to bind or “catch” the soil/stain particles (by the use of the term soil hereinafter we also includes stains). This may take less than 1 hour, for example less than 30 minutes, preferably less than 10 minutes.

The composition is then removed from the laundry item. Optionally, the composition is removed in the absence of water, for example, by brushing the composition off the laundry item. In one embodiment, however, the composition is removed using water, for example, by rinsing the laundry item by hand or in a washing machine. The process of the present invention, therefore, may be carried out before the laundry item is washed by hand or in a laundry washing machine.

The cleaning composition may contain at least one additional active agent, such as a surfactant and/or bleach. The surfactant or bleach may dissolve at least in part upon contact with the soil. The surfactant or bleach may be oil soluble and/or water soluble. Suitable surfactants and bleaches are described in detail below.

Although the cleaning composition may contain a surfactant, the amount of surfactant in the cleaning composition is preferably less than 30% wt, more preferably less than 20% wt, even more preferably less than 10% wt, for example, less than 5% wt. In one embodiment, the composition comprises less than 3% wt surfactant. In another embodiment, the composition is substantially free of surfactant.

Any suitable soil catcher may be employed. Unlike detergents or surfactants, which simply aid in the removal of soils from surfaces, the soil catcher actively binds to the soil allowing it to be removed from the surface of the laundry. Once bound, the soil is less likely to be able to redeposit onto the surface of the laundry. Preferred soil catchers have a high affinity to both oily and water-soluble soil. Preferably, the soil catcher is a mixture of two or more soil catchers, each soil catcher may have a different affinity for different soils. Preferred soil catchers for oily soils have a non polar structure with high absorption capability. Preferred water based soil catchers are generally charged and have a high surface area in order to attract the soil by electrostatic charge and collect it.

Suitable soil catchers include polymers, such as acrylic polymers, polyesters and polyvinylpyrrolidone (PVP). The polymers may be crosslinked, examples of which include crosslinked acrylic polymers and crosslinked PVP. Super absorbing polymers are mainly acrylic polymers and they are useful for the scope of this patent.

Other important polymers are ethylidene norbene polymers, ethylidene norbene/ethylene copolymers, ethylidene norbene/propylene/ethylidene ter-polymers. Inorganic materials may also be employed. Examples include silica, silicates (e.g. magnesium silicate), zeolites, talc, bentonites and active carbon. The latter may be used to absorb and/or degrade coloured parts of stain and/or absorb odours. Alginates, carrageneans and chitosan may also be used. Preferred water insoluble agents are selected from at least one of acrylic polymer, polyester, polyvinylpyrrolidone (PVP), silica, silicate, zeolite, talc, bentonites, active carbon, alginates, carrageneans, ethylidene morbene/propylene/ethylidene ter-polymers and chitosan in the manufacture of a cleaning composition as an active agent for binding soil. Preferably the cleaning composition is a laundry cleaning composition or stain-removing composition.

Preferably, the water-insoluble soil catcher compound would comprise a solid cross-linked polyvinyl N-oxide, or chitosan product or ethylidene norbene/propylene/ethylidene ter-polymers or blend of the same, as discussed more fully hereafter. Products made in accordance with the present invention which are suitable for use individually can be provided in a variety forms, but will at least contain a compartment for storing a water-insoluble soil catcher compound and have a plurality of apertures, as previously described.

The laundry devices of the present invention can-be used with a variety of water-insoluble soil catcher compounds. These water-insoluble soil catcher compounds can be provided as a solid, gel, and the like.

These soil catcher compounds can deliver the soil catcher benefit by a variety of techniques, including, but not limited to trapping the soil in such a manner that it is unavailable for re-deposition onto a fabric, precipitating out the soil or adsorbing, absorbing or otherwise becoming associated with any extraneous soil in the wash water.

As used herein, the phrase “substantially water insoluble” is intended to mean that the soil catcher compound has a solubility in deionised water at 20° C. of less than about 1 gm/litre. A substantially water insoluble soil catcher compound may comprise a water-soluble soil catcher agent which is bound to a water insoluble carrier, or it may comprise a soil catcher agent which in itself is water insoluble. Water insoluble carriers for water-soluble polymeric agents include inorganic materials such as zeolites, clays such as kaolinites, smectites, hectorite types, silicas (or other detergent ingredients). Additionally, organic water-insoluble materials such as fatty alcohols, esters of fatty acids, or polysaccharides that can form water-insoluble gels upon hydration (e.g. gellan gum, carrageenan gum, agarose etc.) can be used as carriers herein. For the soil catcher agents which are themselves water soluble, water insolubility can be achieved by cross-linking, either starting from the known water-soluble soil catcher polymeric agents, or starting from monomers of these polymers. Other compounds that are suitable as water insoluble soil catcher agents are any compound exhibiting ion exchange properties, preferably anion exchangers. For instance, non-limiting examples of such products are Dowex® exchange resins of the Dow Chemical Co. or equivalent from other suppliers; Sephadex®, Sepharose® or Sephacel® exchange resins all from Pharmacia Biotech; any other polysaccharide having ion exchange properties such as modified cellulosics, starches; other derivatives of the wood industry such as wood pulp or lignin.

Water soluble polymeric soil catcher agents that are suitable to be bound to insoluble carriers, or to be made insoluble via cross-linking are those polymers known in the art to inhibit the transfer of dyes from coloured fabrics onto fabrics washed therewith. These polymers have the ability to complex or adsorb the fugitive dyes washed out of dyed fabrics before the dyes have the opportunity to become attached to other articles in the wash. Especially suitable polymeric soil catcher agents are polyamine N-oxide polymers, polymers and copolymers of N-vinylpyrrolidone and N-vinylimidazole, vinyloxazolidones, vinylpyridine, vinylpyridine N-oxide, other vinylpyridine derivatives or mixtures thereof.

a) Polyamine N-Oxide Polymers

The polyamine N-oxide polymers suitable for use contain units having the following structure formula:

P-Aₓ-R—N—O

wherein P is a polymerisable unit, whereto the R—N—O group can be attached to, when x is 0, or wherein the R—N—O group forms part of the polymerisable unit or a combination of both;

A is —C(0)0-, -0C(O)—, —C(0)-, -0-, —S—, —N_{<}; and x is 0 or 1;

R is aliphatic, ethoxylated aliphatics, aromatic, heterocyclic or alicyclic groups or any combination thereof whereto the nitrogen of the N—O group can be attached or wherein the nitrogen of the N—O group is part of these groups.

The N—O group can be represented by the following general structures:

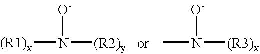

wherein R1, R2, and R3 are aliphatic groups, aromatic, heterocyclic or alicyclic groups or combinations thereof, x or/and y or/and z is 0 or 1 and wherein the nitrogen of the N—O group can be attached or wherein the nitrogen of the N—O group forms part of these groups.

The N—O group can be part of the polymerisable unit P or can be attached to the polymeric backbone or a combination of both.

Suitable polyamine N-oxides wherein the N—O group forms part of the polymerisable unit comprise polyamine N-oxides wherein R is selected from aliphatic, aromatic, alicyclic or heterocyclic groups. One class of said polyamine N-oxides comprises the group of polyamine N-oxides wherein the nitrogen of the N—O group forms part of the R-group. Preferred polyamine N-oxides are those wherein R is a heterocyclic group such as pyridine, pyrrole, imidazole, pyrrolidine, piperidine, quinoline, acridine and derivatives thereof. Another class of said polyamine N-oxides comprises the group of polyamine N-oxides wherein the nitrogen of the N—O group is attached to the R-group. Other suitable polyamine N-oxides are the polyamine oxides wherein the N—O group is attached to the polymerisable unit. Preferred classes of these polyamine N-oxides are the polyamine N-oxides having the general formula above wherein R is an aromatic, heterocyclic or alicyclic groups wherein the nitrogen of the N—O functional group is part of said R group. Examples of these classes are polyamine oxides wherein R is a heterocyclic compound such as pyridine, pyrrole, imidazole and derivatives thereof. Another preferred class of polyamine N-oxides is the polyamine oxides having the general formula above wherein R are aromatic, heterocyclic or alicyclic groups wherein the nitrogen of the N—O functional group is attached to said R groups. Examples of these classes are polyamine oxides wherein R groups can be aromatic such as phenyl.

Any polymer backbone can be used as long as the amine oxide polymer formed has soil catcher properties. Examples of suitable polymeric backbones are polyvinyls, polyalkylenes, polyesters, polyethers, polyamide, polyimides, polyacrylates and mixtures thereof. The amine N-oxide polymers of the present invention typically have a ratio of amine to the amine N-oxide of about 10:1 to about 1:1000000. However the amount of amine oxide groups present in the polyamine oxide polymer can be varied by appropriate copolymerisation or by appropriate degree of N-oxidation. Preferably, the ratio of amine to amine N-oxide is from about 2:3 to about 1:1000000. More preferably from about 1:4 to about 1:1000000, and most preferably from about 1:7 to about 1:1000000. The polymers of the present invention may encompass random or block copolymers where one monomer type is an amine N-oxide and the other monomer type is either an amine N-oxide or not. The amine oxide unit of the polyamine N-oxides has a pKa<10, preferably pKa<7, more preferred pKa<6. The polyamine oxides can be obtained in almost any degree of polymerisation. The degree of polymerisation is not critical provided the material has the desired dye-suspending power. Typically, the average molecular weight is within the range of about 500 to about 1,000,000; preferably from about 1,000 to about 50,000, more preferably from about 2,000 to about 30,000, and most preferably from about 3,000 to about 20,000.

b) Copolymers of N-vinvlpyrrolidone and N-vinylimidazole The N-vinylimidazole N-vinylpyrrolidone polymers used in the present invention have an average molecular weight range from about 5,000 to about 1,000,000, preferably from about 5,000 to about 200,000. Highly preferred polymers for use in the laundry detergent compositions according to the present invention comprise a polymer selected from N-vinylimidazole N-vinylpyrrolidone copolymers wherein said polymer has an average molecular weight range from about 5,000 to about 50,000; more preferably from about 8,000 to about 30,000; and most preferably from about 10,000 to about 20,000. The average molecular weight range was determined by light scattering as described in Barth H. G. and Mays J. W. Chemical Analysis Vol 113, “Modern Methods of Polymer Characterisation”. Highly preferred N-vinylimidazole N-vinylpyrrolidone copolymers have an average molecular weight range from about 5,000 to about 50,000; more preferably from about 8,000 to about 30,000; most preferably from about 10,000 to about 20,000. The N-vinylimidazole N-vinylpyrrolidone copolymers characterised by having said average molecular weight range provide excellent soil catcher properties. The N-vinylimidazole N-vinylpyrrolidone copolymer of the present invention has a molar ratio of N-vinylimidazole to N-vinylpyrrolidone from about 1 to about 0.2, more preferably from about 0.8 to about 0.3, and most preferably from about 0.6 to about 0.4

c) Polyvinylpyrrolidone

Polyvinylpyrrolidone (“PVP”) having an average molecular weight from about 2,500 to about 400,000 can also be utilised; preferably of average molecular weight from about 5,000 to about 200,000; more preferably from about 5,000 to about 50,000; and most preferably from about 5,000 to about 15,000. Suitable polyvinylpyrrolidones are commercially available from ISP Corporation, New York, N.Y. and Montreal, Canada under the product names PVP K-15 (viscosity molecular weight of 10,000), PVP K-30 (average molecular weight of 40,000), PVP K-60 (average molecular weight of 160,000), and PVP K-90 (average molecular weight of 360,000). Other suitable polyvinylpyrrolidones which are commercially available from BASF include Sokalan HP 165 and Sokalan HP 12; polyvinylpyrrolidones known to persons skilled in the detergent field (see for example EP-A-262,897 and EP-A-256,696).

d) Polyvinyloxazolidone

One may also utilise polyvinyloxazolidone as a polymeric soil catcher agent. Said polyvinyloxazolidones have an average molecular weight from about 2,500 to about 400,000; preferably from about 5,000 to about 200,000; more preferably from about 5,000 to about 50,000; and most preferably from about 5,000 to about 15,000.

e) Polyvinylimidazole

One may also utilise polyvinylimidazole as polymeric soil catcher agent. Said polyvinylimidazoles have an average molecular weight from about 2,500 to about 400,000; preferably from about 5,000 to about 200,000; more preferably from about 5,000 to about 50,000; and most preferably from about 5,000 to about 15,000.

f) Cationic Polymers

Such polymers are those having a cationic group into their polymeric backbone, as shown by the formula:

[P-Catₓ]ₙ-Zₜ-Cat_{y}

Wherein P represents polymerisable units, Z represents an alkyl, aryl carbonyl ester, ether, amide or amine group, Cat represents cationic groups, preferably including quaternised N groups or other cationic units, x=0 or 1, y=0 or 1, t=0 or 1. Preferred cationic polymers are quaternised polyvinylpyridines.

Water insolubility can, in the case of non-cross linked polymers, also be achieved by selecting very high molecular weight range, or by copolymerising, or by varying the degree of oxidation if appropriate, depending on the polymer. Polymers which are water soluble, such as those described in U.S. Pat. No. 5,912,221, may be made insoluble if the molecular weight is increased above 400,000.

g) Cross-Linked Polymers

Cross-linked polymers are polymers whose backbones are interconnected to a certain degree; these links can be of chemical or physical nature, possibly with active groups on the backbone or on branches; cross-linked polymers have been described in the Journal of Polymer Science, volume 22, pages 1035-1039. In one embodiment, the cross-linked polymers are made in such a way that they form a three-dimensional rigid structure, which can entrap dyes in the pores formed by the three-dimensional structure. In another embodiment, the cross-linked polymers entrap the dyes by swelling. Such cross-linked polymers are described in U.S. Pat. No. 5,912,221.

Thus, a cross-linked polymer has one or more individual molecular chains linked by side branches to adjacent chains. The cross-links can be formed: (a) between already existing linear or branched polymers, (b) during the polymerisation of multi-functional monomers, or (c) during the polymerisation of dimeric monomers with traces of multi-functional monomers. The cross-linking can also be achieved by various means known in the art. For instance, the cross-links can be formed using radiation, oxidation and curing agents, such as divinylbenzene, epichlorohydrin and the like. Preferably, cross-linked polymers for the purpose of this invention are those obtained by cross-linking a water-soluble soil catcher polymer described above with divinylbenzene (DVB)cross-linking agent during polymerisation of the soil catcher monomer. Cross-linking degree can be controlled by adjusting the amount of divinylbenzene (DVB) cross-linking agent. Preferably, the degree of cross-linking is between about 0.05% wt of DVB over soil catcher monomer and about 50% of DVB over soil catcher monomer and, more preferably, between about 0.05% wt of DVB over soil catcher monomer and about 25% wt of DVB over soil catcher monomer. Most preferably, the degree of cross-linking is between about 0.1% wt of DVB over soil catcher monomer and about 5% wt of DVB over soil catcher monomer. The cross linking forms soil catcher compound particles, at least 90% of which by total weight of particles (and more preferably at least about 95%) have a d₅₀ particle size of at least about 1 μm, preferably at least about 50 μm, and more preferably at least about 75 μm, all as measured in their dry state. The d₅₀ particle size is the particle size or weight median particle diameter which 50% wt of the particles are larger than, and 50% wt are smaller than. It may suitably be determined by mechanical sieving. Most preferably, the cross linking forms soil catcher compounds, at least 90% (and more preferably at least about 95%) of which have a d₅₀ particle size of between about 1 μm and about 5 mm, still more preferably between about 50 μm and about 2500 μm, and yet still more preferably between about 75 μm and about 1500 μm, all as measured in their dry state. Preferably, the cross-linked polymer is a polyamine N-oxide or a quaternised polyamine. The person skilled in the art may conveniently obtain such compounds by oxidising or quaternizing cross-linked polyvinylpyridines from Reilly Industries Inc. commercialised under the name Reillex™ 402 or Reillex™ 425 by methods known in the art. For instance, but not exclusively, the method described in U.S. Pat. No. 5,458,809 can be used to prepare a polyamine N-oxide of interest from the commercially available compounds given above. An example of quaternised polyamine can also be obtained from Reilly Industries under the commercial name Reillex™ HPQ.

Super absorbing polymers such as acrylic cross linked polymers are useful within the scope of this patent. Examples are Alcosorb grades from Ciba, Acusol from Rohm & Haas and Cabloc from Degussa.

Other important polymers are ethylidene norbene polymers, ethylidene norbene/ethylene copolymers, ethylidene norbene/propylene/ethylidene ter-polymers.

The soil catcher may be present in the cleaning composition in an amount of 0.01 to 100% wt of the composition, preferably from 1 to 90% wt, more preferably from 5 to 50 % wt.

The cleaning composition may optionally contain a filler. Suitable fillers are described in detail below. The cleaning composition may also contain additives, such as builders, chelating agents, solvents, enzymes, fragrances, and anti-caking agents, as described in further detail below.

The cleaning composition is preferably in the form of a powder. By “powder” we mean any solid, flowable composition. Thus the powder may, for example, be in the form of granules or agglomerated particles. It may, however, be in the form of a loose agglomeration of particles. The d₅₀ particle size of the particles may range from 0.001 μm to 10 mm, preferably from 0.01 μm to 2 mm, and more preferably from 0.1 μm to 2 mm, for example 1 μm to 1 mm.

The cleaning composition may be enclosed in an enclosing wall or container which is permeable to water and to components dissolved therein. Such an enclosed product may be used in the washing cycle of a laundry washing machine.

A second aspect of the present invention provides a laundry product having an enclosing wall and containing a composition in the form of a powder, said composition comprising an insoluble active agent which is capable of binding soil, the wall being permeable to water and to components dissolved therein, wherein, after the product has been contacted with water in a laundry washing machine, the insoluble active agent remains within the enclosing wall.

The laundry product of the present invention combines the advantages of a unit-dose product with an active agent which is capable of binding soil or “soil catcher” product.

The composition advantageously additionally comprises cleaning agents selected from the group consisting of surfactants, bleaches, activators, enzymes or a mixture thereof. These active agents are generally water soluble, so dissolve during the wash. Thus the additional active agents are released over a period of time when exposed to water in the laundry washing machine.

An advantage of the present invention is that the cleaning product is more versatile since the enclosing wall can have an additional function. For example the product can be contacted with or rubbed on laundry before it is added into the laundry washing machine. In this way a pre-treatment can be carried out depending on the nature of the product.

The cleaning product has an enclosing wall which is permeable to water and to components dissolved therein. The enclosing wall may also be permeable to oils and other soil or stain components suspended or dispersed in water. However, the wall is impermeable to the powder held within the product.

The enclosing wall may be have a portion which is insoluble and permeable to water, and another portion which is insoluble and impermeable to water. In use, a user may hold the product by the impermeable wall section and, for example, press the permeable wall section directly with the stain. In this way, contact between the user's hands and the contents of the enclosing wall is avoided.

By water permeable we mean having a water permeability of at least 1000 l/m²/s at 100 Pa according to DIN EN ISO 9237. In addition the wall must not be so permeable that it is not able to hold the powder composition. Thus, for example, the wall may have a mesh size of less than 250 microns, preferably less than 150 microns, more preferably less than 50 microns.

The product should not be able to move out of the drum, such as by entering the internal pipework of the washing machine and onto the filter. Thus if it is intended to be added direct to the drum it is generally large, preferably having a minimum length and width of at least 120 mm.

The product is preferably flat, i.e. its thickness is at least 5 times less, preferably at least 10 times less, ideally at least 30 times less, than each of its other two dimensions, the width and the length (which are the same as each other when the product is square or circular in plan).

The product may be placed with the laundry to be washed in an automatic laundry washing machine. The closed product preferably resists a laundry wash cycle (2 h wash/rinse/spin cycle, 95° C., spinning at 1600 rpm) without opening. The product may be discarded after use.

The product may also be used in a stain treating step prior to placing into an automatic laundry washing machine. For example, the product may be wet with water and used directly onto the stain by a scrubbing action. When the composition starts to dissolve, it may be released through the enclosing wall or container to the treated garment area.

Alternatively, the laundry product may be placed in a bucket with water and the stained laundry. After soaking the laundry for a predetermined period of time, the laundry may be removed. In one embodiment, the laundry is allowed to soak a period of time ranging from 1 minute to overnight, preferably from 10 minutes to 6 hours.

The product may be formed into a flat container or a sachet. The sachet may measure at least 2 cm across. Preferably, the sachet measures at least 10 cm across. The sachet is preferably sufficiently large for it to be held conveniently by hand and applied directly to the soiled laundry item.

The sachet may be formed from a sandwich of two webs. A water permeable sheet or film is present in one of the webs, at least, and forms at least one wall of the container. The water-permeable outer wall may comprise, for example, a woven, knitted or preferably non-woven material, of textile, polymer or paper. Suitable polymers include cellular polymer materials. The material may be in the form of single layer or laminated layers. Preferably the wall comprises a sheet with a ply of one, two or three layers, such that any non-dissolved or insoluble agent inside the container is too large to pass through the perforation(s) or would have to follow an impossibly tortuous pathway if it were to exit the container through the wall. Preferably the sheet is a woven or non-woven material.

The product may conveniently comprise two webs sealed together about-their periphery, with the contents held inside. The sealing may be by means of adhesive or dielectric welding or, preferably, heat sealing or, most preferably, ultrasound sealing. When the sealing is by heat sealing the sheets may comprise a thermoplastic to facilitate this. The material forming the adhesive strips can be a so called hot melt comprising various materials, such as APP, SBS, SEBS, SIS, EVA and the like, or a cold glue, such as a dispersion of various materials, e.g. SBS, natural rubber and the like, or even a solvent-based or a two-component adhesive system. Furthermore, the material may be capable of crosslinking to form specific, permanent chemical bonds with the various layers. Polyethylene glycols with different molecular weights can be used as well, having average molecular weights ranging from 1000 to 20000, most preferred ones are from 2000 to 8000. The amount of adhesive used is a function of the type of adhesive selected. However it is generally from 0.2 to 20 g/m².

Conventional materials used in tea bag manufacture or in the manufacture of sanitary or diaper products may be suitable, and the techniques used in making tea bags or sanitary products can be applied to make flexible products useful in this invention. Such techniques are described in WO 98/36128, U.S. Pat. No. 6,093,474, EP-A-708,628 and EP-A-380,127. U.S. Pat. No. 5,053,270 also describes a method of forming a flexible product useful in this invention.

Conveniently the two webs are non-wovens. Processes for manufacturing nonwoven fabrics can be grouped into four general categories leading to four main types of nonwoven products, textile-related, paper-related, extrusion-polymer processing related and hybrid combinations.

Textiles. Textile technologies include garneting, carding, and aerodynamic forming of fibres into selectively oriented webs. Fabrics produced by these systems are referred to as drylaid nonwovens, and they carry terms such as garneted, carded, and airlaid fabrics. Textile-based nonwoven fabrics, or fibre-network structures, are manufactured with machinery designed to manipulate textile fibres in the dry state. Also included in this category are structures formed with filament bundles or tow, and fabrics composed of staple fibres and stitching threads.

In general, textile-technology based processes provide maximum product versatility, since most textile fibres and bonding systems can be utilised.

Paper. Paper-based technologies include drylaid pulp and wetlaid (modified paper) systems designed to accommodate short synthetic fibres, as well as wood pulp fibres. Fabrics produced by these systems are referred to as drylaid pulp and wetlaid nonwovens. Paper-based nonwoven fabrics are manufactured with machinery designed to manipulate short fibres suspended in fluid.

Extrusions. Extrusions include spunbond, meltblown, and porous film systems. Fabrics produced by these systems are referred to individually as spunbonded, meltblown, and textured or apertured film nonwovens, or generically as polymer-laid nonwovens. Extrusion-based nonwovens are manufactured with machinery associated with polymer extrusion. In polymer-laid systems, fibre structures simultaneously are formed and manipulated.

Hybrids. Hybrids include fabric/sheet combining systems, combination systems, and composite systems. Combining systems employ lamination technology or at least one basic nonwoven web formation or consolidation technology to join two or more fabric substrates. Combination systems utilize at least one fabric substrate. Composite systems integrate two or more basic nonwoven web formation technologies to produce web structures. Hybrid processes combine technology advantages for specific applications.

Suitable materials for forming the enclosing wall are paper or a polyolefin, such as polyethylene or polypropylene, or another polymer such as a polyester or polyamide. Suitably the enclosing wall comprises a water-permeable, water-insoluble web, preferably of one or a mixture of the above materials. The enclosing wall is preferably a woven or non-woven web. The materials making up the enclosing wall are preferably in the form of fibres.

The surface of the enclosing wall may be subjected to corona or plasma treatment or a permanent chemical treatment, for example with cationic polymers. All these treatments may give rise to an increase in the affinity of organic molecules to the substrate through ionic or polar interaction. By doing this the free stain molecules in the wash liquor are captured by the wall of the product which work as a filter, reducing the stain re-deposition on fabrics.

The enclosing wall may also be formed of a cellular plastics material. Suitable cellular plastics for forming the enclosing wall have densities of 1 to 500 kgm⁻³, preferably from 20 to 80 kgm⁻³ and with an average pore diameter of at least 0.1 mm, preferably at least 0.4 mm. Ideally, the cellular plastics has a porosity of greater than 50%, preferably greater than 60%, more preferably greater than 70%, most preferably greater than 80%.

The porosity is determined by using a dry automatic densimeter by to measure the apparent volume and true volume of the cellular plastic material. The porosity is then calculated in accordance with the following equation:

Porosity %=[apparent volume-true volume)/apparent volume]×100

The “average pore diameter” is a value measured in accordance with ASTM (Designation: D4404-84) and is specifically a value determined by the measurement of the diameter of pores in accordance with a mercury penetration process using a mercury porosimeter manufactured by Porous Material, Inc.

Suitable cellular plastics materials are those readily available for example from Euro foam, Miarka and Menshen and are made from any suitable water-insoluble plastic such as cellulose, polyurethane, polyester, polyether, or blends thereof.

The product of the present invention may have an enclosing wall which has a roughened outer surface. The roughened outer surface may be provided by the wall being in the form of woven or non-woven fibres. The roughness of the surface depends on, for example, the diameter of the fibres. The roughened outer surface may also be provided by ensuring that an otherwise uniform outer wall has a surface texture.

This could be provided, for example, by including particulate matter in the wall or by forming the wall in an appropriate manner. A roughened outer surface may provide a number of advantages. For example, it ensures that the product is less likely to slip out of a consumer's hand, particularly when the product is damp and hence slippery. It also assists a secondary function of the product, that is to provide a pre-treatment of the laundry before it is washed. The product may simply be contacted with or rubbed on the laundry, especially a stained part thereof, to treat the laundry before washing, for example to remove a stain or assist in stain removal. Some of the cleaning composition from inside the product may leach outside to assist in this pre-treatment. It is also possible for an additional agent to be attached to the outside of the product.

The enclosing wall of the product may be a cellulosic material, for example a cellulosic textile or paper material.

The product of the present invention is preferably such that, after it has been contacted with water in a ware washing machine, less than 80% wt of the cleaning composition remains, preferably less than 50% wt and most preferably less than 30% wt. This is with reference to the product placed in the drum of a standard laundry washing machine, such as a Bosch WFR 3240 washing machine, at a standard washing cycle, in particular a cotton cycle at 40-60° C., and at any water hardness, but preferably at a water hardness of 18 to 24° dH (German degrees). Preferably, at least 5, 10, 15, 20 or 25% wt of the cleaning composition remains in the product after it has thus been contracted with water in a ware washing machine. The residue in the product is preferably mainly composed of the soil catcher. In another embodiment of the present invention, the product may open up completely during wash cycle in the wash drum, releasing all its content and binding loose dye and dirt on the product wall. Preferably a Bosch WFR 3240 laundry washing machine is,used at a cotton cycle at 60° C. and at a water hardness of 18° dH. For the avoidance of doubt, even though this test uses a particular laundry washing machine, the laundry treatment product of the present invention can be used in any laundry washing machine at any cycle. If the product meets the above test, it is capable of being used in any laundry machine at any cycle.

The composition may optionally contain a filler. Suitable fillers include bicarbonates and carbonates of metals, such as alkali metals and alkaline earth metals. Examples include sodium carbonate, sodium bicarbonate, calcium carbonate, calcium bicarbonate, magnesium carbonate, magnesium bicarbonate and sesqui-carbonates of sodium, calcium and/or magnesium. Other examples include metal carboxy glycine and metal glycine carbonate. Chlorides, such as sodium chloride; citrates; and sulfates, such as sodium sulfate, calcium sulfate and magnesium sulfate, may also be employed.

The filler may be present in an amount of 0.1 to 80% wt, preferably 1 to 60% wt.

The product may also be provided with a binder. The binder may help to distribute the soil catcher uniformly throughout the enclosed wall, for example, by attaching or “gluing” the soil catcher to the surface of the inner wall.

Examples of binders include APP, SBS, SEBS, SIS, EVA and soluble systems, such as polyethylene glycol with molecular weight ranging from 1000 to 20000, or mixtures. The binders may be pre-mixed with the cleaning composition, for example in an amount of from 0.1 to 50% wt, preferably from 1 to 10% wt.

The product optionally contains an active agent, such as a surfactant or bleach or mixtures thereof, which is capable of being washed away. When a surfactant is present in the composition, it may be present in an amount of, for example, from 0.01 to 50% wt, ideally 0.1 to 30% wt and preferably 0.5 to 10% wt.

Suitable surfactants that may be employed in all aspects of the present invention include anionic or nonionic surfactants or mixture thereof. The nonionic surfactant is preferably a surfactant having a formula RO(CH₂CH₂O)ₙH wherein R is a mixture of linear, even carbon-number hydrocarbon chains ranging from C₁₂H₂5 to C₁₆H₃₃ and n represents the number of repeating units and is a number of from about 1 to about 12. Examples of other non-ionic surfactants include higher aliphatic primary alcohol containing about twelve to about 16 carbon atoms which are condensed with about three to thirteen moles of ethylene oxide per mole of alcohol (i.e. equivalents).

Other examples of nonionic surfactants include primary alcohol ethoxylates. (available under the Neodol tradename from Shell Co.), such as Cl, alkanol condensed with 9 equivalents of ethylene oxide (Neodol 1-9), C₁₂-₁₃ alkanol condensed with 6.5 equivalents ethylene oxide (Neodol 23-6.5), C₁₂₋₁₃ alkanol with 9 equivalents of ethylene oxide (Neodol 23-9), C₁₂-₁₅ alkanol condensed with 7 or 3 equivalents ethylene oxide (Neodol 25-7 or Neodol 25-3), C₁₄-₁₅ alkanol condensed with 13 equivalents ethylene oxide (Neodol 45-13), C₉₋₁₁ linear ethoxylated alcohol, averaging 2.5 moles of ethylene oxide per mole of alcohol (Neodol 91-2.5), and the like.

Other examples of nonionic surfactants suitable for use in the present invention include ethylene oxide condensate products of secondary aliphatic alcohols containing 11 to 18 carbon atoms in a straight or branched chain configuration condensed with 5 to 30 equivalents of ethylene oxide. Examples of commercially available non-ionic detergents of the foregoing type are C₁₁₋₅ secondary alkanol condensed with either 9 equivalents of ethylene oxide (Tergitol 15-S-9) or 12 equivalents of ethylene oxide (Tergitol 15-S-12) marketed by Union Carbide, a subsidiary of Dow Chemical.

Octylphenoxy polyethoxyethanol type nonionic surfactants, for example, Triton X-100, as well as amine oxides can also be used as a nonionic surfactant in the present invention.

Other examples of linear primary alcohol ethoxylates are available under the Tomadol tradename such as, for example, Tomadol 1-7, a C₁₁ linear primary alcohol ethoxylate with 7 equivalents EO; Tomadol 25-7, a C₁₂₋₁₅ linear primary alcohol ethoxylate with 7 equivalents EO; Tomadol 45-7,a C₁₄₋₁₅ linear primary alcohol ethoxylate with 7 equivalents EO; and Tomadol 91-6, a C₉₋₁₁ linear alcohol ethoxylate with 6 equivalents EO.

Other nonionic surfactants are amine oxides, alkyl amide oxide surfactants.

Preferred anionic surfactants are frequently provided as alkali metal salts, ammonium salts, amine salts, aminoalcohol salts or magnesium salts. Contemplated as useful are one or more sulfate or sulfonate compounds including: alkyl benzene sulfates, alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Other surfactants which may be used are alkyl naphthalene sulfonates and oleoyl sarcosinates and mixtures thereof.

Examples of bleaches that may be used in all aspects of the present invention are oxygen bleaches. A suitable level of oxygen bleaches is in the range from 0.01 to 80% wt; a preferred level is from 0.1 to 70% wt, ideally 1 to 60% wt. As used herein active oxygen concentration refers to the percentage concentration of elemental oxygen, with an oxidation number zero, that being reduced to water would be stoichiometrically equivalent to a given percentage concentration of a given peroxide compound, when the peroxide functionality of the peroxide compound is completely reduced to oxides. The active oxygen sources increase the ability of the compositions to remove oxidisable stains, to destroy malodorous molecules and to kill germs.

The concentration of available oxygen can be determined by methods known in the art, such as the iodimetric method, the permanganometric method and the cerimetric method. Said methods and the criteria for the choice of the appropriate method are described for example in “Hydrogen Peroxide” , W. C. Schumo, C. N. Satterfield and R. L. Wentworth, Reinhold Publishing Corporation, New York, 1955 and “Organic Peroxides”, Daniel Swern, Editor Wiley Int. Science, 1970.

Suitable organic and inorganic peroxides for use in the compositions according to the present invention include diacyl and dialkyl peroxides such as dibenzoyl peroxide, dilauroyl peroxide, dicumyl peroxide, persulphuric acid and mixtures thereof.

A bleach of use in the present invention may be preformed or formed in situ, from a bleach persursor.

Suitable preformed peroxyacids for use in the compositions according to the present invention include diperoxydodecandioic acid DPDA, magnesium perphthalatic acid, perlauric acid, perbenzoic acid, diperoxyazelaic acid and mixtures thereof. Peroxygen bleaching actives useful for this invention are: percarbonates, perborates, peroxides, peroxyhydrates, persulfates. A preferred compound is sodium percarbonate and especially the coated grades that have better stability. The percarbonate can be coated with silicates, borates, waxes, sodium sulfate, sodium carbonate and surfactants solid at room temperature.

Optionally, the compositions of all aspects of the present invention may additionally comprise from 0.01 to 30% wt, preferably from 2 to 20% wt of bleach precursors. Suitable bleach precursors are peracid precursors, i.e. compounds that upon reaction with hydrogen peroxide product peroxyacids. Examples of peracid precursors suitable for use in the present invention can be found among the classes of anhydrides, amides, imides and esters such as acetyl triethyl citrate (ATC), tetra acetyl ethylene diamine (TAED), succinic or maleic anhydrides.

The composition of all aspects of the present invention may, for example, comprise at least one builder or a combination of them, for example in an amount of from 0.01 to 80% wt, preferably from 0.1 to 50% wt. Builders may be used as chelating agents for metals, as anti-redeposition agents and/or as alkalis.

Examples of builders are described below:
the parent acids of the monomeric or oligomeric polycarboxylate chelating agents or mixtures thereof with their salts, e.g. citric acid or citrate/citric acid mixtures are also contemplated as useful builder components.
borate builders, as well as builders containing borate-forming materials than can produce borate under detergent storage or wash conditions can also be used.
iminosuccinic acid metal salts.
polyaspartic acid metal salts.
ethylene diamino tetra acetic acid and salt forms.
water-soluble phosphonate and phosphate builders are useful for this invention. Examples of phosphate builders are the alkali metal tripolyphosphates, sodium potassium and ammonium pyrophosphate, sodium and potassium and ammonium pyrophosphate, sodium and potassium orthophosphate sodium polymeta/phosphate in which the degree of polymerisation ranges from 6 to 21, and salts of phytic acid. Specific examples of water-soluble phosphate builders are the alkali metal tripolyphosphates, sodium, potassium and ammonium pyrophosphate, sodium, potassium and ammonium pyrophosphate, sodium and potassium orthophosphate, sodium polymeta/phosphate in which the degree of polymerization ranges from 6 to 21, and salts of phytic acid. Such polymers include polycarboxylates containing two carboxy groups, water-soluble salts of succinic acid, malonic acid, (ethylenedioxy)diacetic acid, maleic acid, diglycolic acid, tartaric acid, tartronic acid and fumaric acid, as well as the ether carboxylates and the sulfinyl carboxylates.

Polycarboxylates containing three carboxy groups include, in particular, water-soluble citrates, aconitrates and citraconates as well as succinate derivates such as the carboxymethloxysuccinates described in GB-A-1,379,241, lactoxysuccinates described in GB-A-1,389,732, and aminosuccinates described in NL-A-7205873, and the oxypolycarboxylate materials such as 2-oxa-1,1,3-propane tricarboxylates described in GB-A-1,387,447.

Polycarboxylate containing four carboxy groups include oxydisuccinates disclosed in GB-A-1,261,829, 1,1,2,2-ethane tetracarboxylates, 1,1,3,3-propane tetracarboxylates and 1,1,2,3-propane tetracarobyxlates. Polycarboxylates containing sulfo substituents include the sulfosuccinate derivatives disclosed in GB-A-1,398,421, GB-A-1,398,422 and U.S. Pat. No. 3,936448, and the sulfonated pyrolysed citrates described in GB-A-1,439,000.

Alicylic and heterocyclic polycarboxylates include cyclopentane-cis,cis,cis-tetracarboxylates, cyclopentadienide pentacarboxylates, 2,3,4,5,6-hexane—hexacarboxylates and carboxymethyl derivates of polyhydric alcohols such as sorbitol, mannitol and xylitol. Aromatic polycarboxylates include mellitic acid, pyromellitic acid and the phthalic acid derivatives disclosed in GB-A-1,425,343.

Of the above, the preferred polycarboxylates are hydroxycarboxylates containing up to three carboxy groups per molecule, more particularly citrates.

Suitable polymer water-soluble compounds include the water soluble monomeric polycarboxylates, or their acid forms, homo or copolymeric polycarboxylic acids or their salts in which the polycarboxylic acid comprises at least two carboxylic radicals separated from each other by not more than two carbon atoms, carbonates, bicarbonates, borates, phosphates, and mixtures of any of the foregoing.

The carboxylate or polycarboxylate builder can be monomeric or oligomeric in type although monomeric polycarboxylates are generally preferred for reasons of cost and performance.

Suitable carboxylates containing one carboxy group include the water soluble salts of lactic acid, glycolic acid and ether derivatives thereof. Polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates and the sulfinyl carboxylates. Polycarboxylates containing three carboxy groups include, in particular, water-soluble citrates, aconitrates and citraconates as well as succinate derivates such as the carboxymethloxysuccinates described in GB-A-1,379,241, lactoxysuccinates described in GB-A-1,389,732, and aminosuccinates described in NL-A-7205873, and the oxypolycarboxylate materials such as 2-oxa-1,1,3-propane tricarboxylates described in GB-A-1,387,447. Polycarboxylate containing four carboxy groups include oxydisuccinates disclosed in GB-A-1,261,829, 1,1,2,2-ethane tetracarboxylates, 1,1,3,3-propane tetracarboxylates and 1,1,2,3-propane tetracarobyxlates. Polycarboxylates containing sulfo substituents include the sulfosuccinate derivatives disclosed in GB-A-1,398,421, GB-A-1,398,422 and U.S. Pat. No. 3,936448, and the sulfonated pyrolysed citrates described in GB-A-1,439,000.

Alicylic and heterocyclic polycarboxylates include cyclopentane-cis,cis,cis-tetracarboxylates, cyclopentadienide pentacarboxylates, 2,3,4,5,6-hexane—hexacarboxylates and carboxymethyl derivates of polyhydric alcohols such as sorbitol, mannitol and xylitol. Aromatic polycarboxylates include mellitic acid, pyromellitic acid and the phthalic acid derivatives disclosed in GB-A-1,425,343.

Of the above, the preferred polycarboxylates are hydroxycarboxylates containing up to three carboxy groups per molecule, more particularly citrates.

More preferred polymers are homopolymers, copolymers and multiple polymers of acrylic, fluorinated acrylic, sulfonated styrene, maleic anhydride, metacrylic, iso-butylene, styrene and ester monomers.

Examples of these polymers are Acusol supplied from Rohm & Haas, Syntran supplied from Interpolymer and the Versa and Alcosperse series supplied from Alco Chemical, a National Starch & Chemical Company.

The parent acids of the monomeric or oligomeric polycarboxylate chelating agents or mixtures thereof with their salts, e.g. citric acid or citrate/citric acid mixtures are also contemplated as useful builder components.

Examples of bicarbonate and carbonate builders are the alkaline earth and the alkali metal carbonates, including sodium and calcium carbonate and sesqui-carbonate and mixtures thereof. Other examples of carbonate type builders are the metal carboxy glycine and metal glycine carbonates.

In the context of the present application it will be appreciated that builders are compounds that sequester metal ions associated with the hardness of water, e.g. calcium and magnesium, whereas chelating agents are compounds that sequester transition metal ions capable of catalysing the degradation of oxygen bleach systems. However, certain compounds may have the ability to do perform both functions.

Suitable chelating agents to be used herein include chelating agents selected from the group of phosphonate chelating agents, amino carboxylate chelating agents, polyfunctionally-substituted aromatic chelating-agents, and further chelating agents like glycine, salicylic acid, aspartic acid, glutamic acid, malonic acid, or mixtures thereof. Chelating agents when used, are typically present herein in amounts ranging from 0.01 to 50% wt of the total composition and preferably from 0.05 to 10% wt.

Suitable phosphonate chelating agents to be used herein may include ethydronic acid as well as amino phosphonate compounds, including amino alkylene poly (alkylene phosphonate), alkali metal ethane 1-hydroxy diphosphonates, nitrilo trimethylene phosphonates, ethylene diamine tetra methylene phosphonates, and diethylene triamine penta methylene phosphonates. The phosphonate compounds may be present either in their acid form or as salts of different cations on some or all of their acid functionalities. Preferred phosphonate chelating agents to be used herein are diethylene triamine penta methylene phosphonates. Such phosphonate chelating agents are commercially available from Monsanto under the trade name DEQUEST™.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substituted ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acid is, for instance, commercially available under the tradename ssEDDS™ from Palmer Research Laboratories.

Suitable amino carboxylates to be used herein include ethylene diamine tetra acetates, diethylene triamine pentaacetates, diethylene triamine pentaacetate (DTPA), N-hydroxyethylethylenediamine triacetates, nitrilotriacetates, ethylenediamine tetrapropionates, triethylenetetraaminehexa-acetates, ethanol-diglycines, propylene diamine tetracetic acid (PDTA) and methyl glycine diacetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS™ and methyl glycine di-acetic acid (MGDA).

The cleaning compositions of all aspects of the invention may also comprise fillers. Examples of fillers are sodium chloride, bentonite, zeolites, citrates, talc and metal sulfate salts such as sodium, calcium and aluminium sulfates. They can be used at a level from 0.01 to 60% wt, preferably between 0.1 to 30% wt.

The cleaning compositions of all aspects of the invention may also comprise a solvent. Solvents can be used for present invention in amounts from 0.01 to 30% wt, preferably in amounts of 0.1 to 3% wt. The solvent constituent may include one or more alcohol, glycol, acetate, ether acetate, glycerol, polyethylene glycol with molecular weights ranging from 200 to 1000, silicones or glycol ethers. Exemplary alcohols useful in the compositions of the invention include C2-C8 primary and secondary alcohols which may be straight chained or branched, preferably pentanol and hexanol.

Preferred solvents for the invention are glycol ethers. Examples include those glycol ethers having the general structure Rₐ—O—[CH₂—CH(R)—(CH₂)-0]ₙ-H, wherein Rₐ is C₁₋₂₀ alkyl or alkenyl., or a cyclic alkane group of at least 6 carbon atoms, which may be fully or partially unsaturated or aromatic; n is an integer from 1 to 10, preferably from 1 to 5; and each R is selected from H or CH₃. Specific and preferred solvents are selected from propylene glycol methyl ether, dipropylehe glycol methyl ether, tripropylene glycol methyl ether, propylene glycol n-propyl ether, ethylene glycol n-butyl ether, diethylene glycol n-butyl ether, diethylene glycol methyl ether, propylene glycol, ethylene glycol, isopropanol, ethanol, methanol, diethylene glycol monoethyl ether-acetate, and, especially, propylene glycol phenyl ether, ethylene glycol hexyl ether and diethylene glycol hexyl ether.

The composition may, for example, comprise one enzyme or a combination of them, for example in an amount of from 0.01 to 10% wt, preferably from 0.1 to 2% wt. Enzymes in granular form are preferred. Examples of suitable enzymes are proteases, modified proteases stable in oxidisable conditions, amylases, lipases and cellulases.

Additional, optional, ingredients, selected from a list comprising fragrance, anticaking agent such as sodium xylene sulfonate and magnesium sulfate and dye, may be present, each at levels of up to 5% wt, preferably less then 1% wt.

Stain and/or dye catcher systems useful for the present invention may be mixed to the cleaning composition in an amount ranging from 0.1 to 50% wt, preferably from 1 to 30% wt. They can be optionally also added as filler to the enclosing wall in an amount ranging from 0.1 to 60% wt, more preferably from 1 to 30% wt.

The product of the present invention may also include dispersing or suspending agents that may be released into the wash to aid the soil being bound to the soil catcher. Such agents may be deposited on the enclosing wall of the product, or contained in the enclosing wall with or as part of the cleaning composition. Examples of such agents include carboxy methyl cellulose and acrylic maleic copolymers or acrylic polymers. Such agents may be used in an amount of 0.01 to 30% wt, preferably 0.1 to 10% wt of the cleaning composition.

The enclosing wall may be coated with a water-soluble component, such as a water-soluble polymer, for example a poly(vinyl alcohol).

The present invention also provides a method of cleaning laundry in a laundry washing machine, which comprises adding a product as defined above to the washing machine and conducting the wash.

The present invention is further described in the following Examples.

### EXAMPLES

Powder Absorption Test

The powder absorption capability of the soil catchers listed in Tables 1 and 2 was tested on nut oil and tea, as examples of oil-based and water-based soils, respectively. The liquids were added slowly with stirring to 5 g of soil catcher powder until a creamy composition was obtained. The amount of liquid absorbed per 100 g of soil catcher powder was measured. The results are shown in Tables 3 and 4. Talcum was used as a reference for comparative purposes.

TABLE 1

| | Supplier | Product name | Type |
|---|---|---|---|
| Ex 1 | INEOS Silicas | MICROSIL ED | Synthetic amorphous |
| | | | silica |
| Ex 2 | INEOS Silicas | NEOSYL GP | Silica SiO2 (Syntetic |
| | | | amorphous silica) |
| Ex 3 | INEOS Silicas | NEOSYL AC | Silica SiO2 (Synthetic |
| | | | amorphous silica) |
| Ex 4 | BASF | LUQUASORB MH 4055 | Polyacrylate |
| Ex 5 | ROHM&HAAS | ACUSOL 772 | Super ab. Polymer |
| | | | (Cross-linked |
| | | | Polyacrylate) |
| Ex 6 | CIBA | ALCOSORB AB3C | Super ab. Polymer |
| | | | (Polyacrylamide |
| | | | polymer) |
| Ex 7 | CIBA | ALCOSORB AB3S | Super ab. polymer |
| Ex 8 | CIBA | ALCOSORB G1 | Super ab. polymer |
| Ex 9 | CIBA | ALCOSORB G3 | Super ab. polymer |
| Ex 10 | SUD-CHEMIE | Laundrosil DGA | Bentonite |
| Ex 11 | SUD-CHEMIE | Laundrosil 212 | Sodium form of |
| | | | Bentonite |
| Ex 12 | SUD-CHEMIE | Laundrosil EX 0242 | Natural bentonite |
| Ex 13 | LAVIOSA Chim. | Dellite 67G | Bentonite |
| | Min. S.p.A. | | (Ditallowdimethylammonium |
| | | | Ion with |
| | | | Montmorillonite) |
| Ex 14 | LAVIOSA Chim. | Detercal P1 | Bentonite (Hidrated |
| | Min S.p.A. | | aluminium silicate) |
| Ex 15 | DEGUSSA | Cabloc C96 | Na polyacrylate cross- |
| | | | linked |
| Ex 16 | DEGUSSA | Cabloc CT | Na polyacrylate cross- |
| | | | linked |
| Ex 17 | DEGUSSA | Cabloc CTF | Na polyacrylate cross- |
| | | | linked |
| Ex 18 | DEGUSSA | Favor PAC 230 | Na polyacrylate cross- |
| | | | linked |
| Ex 19 | INEOS Silicas | Zeolite 4A | Zeolite |
| Ex 20 | ISP | Disintex 75 | PVP cross linked |
| Ex 21 | Local supplier | Gypsum | Gypsum |
| Ex 22 | Polichimica | Chitosano 90% | Chitosan |
| Ex 23 | Rokwood | Laponite | Laponite |
| Ex 24 | Rettenmeir | R-modified cellulose | R-modified cellulose |
| Ex 25 | ISP | PVP K30 | PVP |
| Ex 26 | FMC Biopolymer | Protanal Sf 120RB | Alginate |
| Ex 27 | FMC Biopolymer | Protanal Rf 5650 | Alginate |
| Ex 28 | FMC Biopolymer | Gelcarin GP 812 | Carrageenan |
| Ex 29 | FMC Biopolymer | Gelcarin GP 379 | Carrageenan |
| Ex 30 | Degussa | Silica | Silica |
| Ex 31 | Solvay | Na carbonate light | Na carbonate |
| Ex 32 | Local supplier | Kaolin | Kaolin |
| Ex 33 | Solvay | Na carbonate coarse | Na carbonate |
| Ex 34 | INEOS Silicas | Macrosorb MS 15 | Magnesium Silicate |
| Ex 35 | INEOS Silicas | Doucil A28 | Zeolite |
| Ex 36 | INEOS Silicas | Macrosorb MS 33F | Magnesium Silicate |
| Reference | Local supplier | Talcum | Talcum |

TABLE 2

| | | Neosil | | Gelcarin | Na₂CO₃ | | Sodium |
|---|---|---|---|---|---|---|---|
| | Laundosil 212 | GP | Acusol 772 | GP | coarse | Talcum | sulfate |
| | % | % | % | % | % | % | % |
| Ex 37 | 7.5 | 7.5 | 7.5 | 7.5 | 7.5 | 7.5 | 55 |
| Ex 38 | 0 | 0 | 0 | 0 | 0 | 0 | 100 |
| Ex 39 | 15 | 0 | 0 | 0 | 15 | 0 | 70 |
| Ex 40 | 0 | 15 | 0 | 0 | 15 | 15 | 55 |
| Ex 41 | 15 | 15 | 0 | 0 | 0 | 15 | 55 |
| Ex 42 | 0 | 0 | 15 | 0 | 15 | 15 | 55 |
| Ex 43 | 15 | 0 | 15 | 0 | 0 | 15 | 55 |
| Ex 44 | 0 | 15 | 15 | 0 | 0 | 0 | 70 |
| Ex 45 | 15 | 15 | 15 | 0 | 15 | 0 | 40 |
| Ex 46 | 0 | 0 | 0 | 15 | 0 | 15 | 70 |
| Ex 47 | 15 | 0 | 0 | 15 | 15 | 15 | 40 |
| Ex 48 | 0 | 15 | 0 | 15 | 15 | 0 | 55 |
| Ex 49 | 15 | 15 | 0 | 15 | 0 | 0 | 55 |
| Ex 50 | 0 | 0 | 15 | 15 | 15 | 0 | 55 |
| Ex 51 | 15 | 0 | 15 | 15 | 0 | 0 | 55 |
| Ex 52 | 0 | 15 | 15 | 15 | 0 | 15 | 40 |
| Ex 53 | 15 | 15 | 15 | 15 | 15 | 15 | 10 |

TABLE 3

| | | Oil absorbtion | Water absorbtion |
|---|---|---|---|
| | Product name | (g/100 g) | (g/100 g) |
| Ex 1 | MICROSIL ED | 264 | 266 |
| Ex 2 | NEOSYL GP | 288 | 284 |
| Ex 3 | NEOSYL AC | 182 | 188 |
| Ex 4 | LUQUASORB MH 4055 | 48.8 | 2000 |
| Ex 5 | ACUSOL 772 | 38 | 40 |
| Ex 6 | ALCOSORB AB3C | 20 | 1100 |
| Ex 7 | ALCOSORB AB3S | 20 | 700 |
| Ex 8 | ALCOSORB G1 | 37.6 | 92 |
| Ex 9 | ALCOSORB G3 | 30 | 1400 |
| Ex 10 | Laundrosil DGA | 44 | 56 |
| Ex 11 | Laundrosil 212 | 30 | 56 |
| Ex 12 | Laundrosil EX 0242 | 42 | 58 |
| Ex 13 | Dellite 67G | 94 | 88 |
| Ex 14 | Detercal P1 | 34 | 54 |
| Ex 15 | Cabloc C96 | 58 | 92 |
| Ex 16 | Cabloc CT | 62 | 44 |
| Ex 17 | Cabloc CTF | 53 | 70 |
| Ex 18 | Favor PAC 230 | 64 | >2000 |
| Ex 19 | Zeolite 4A | 56 | 52 |
| Ex 20 | Disintex 75 | 211 | 420 |
| Ex 21 | Gypsum | 50 | 45.6 |
| Ex 22 | Chitosano 90% | 150 | 320 |
| Ex 23 | Laponite | 60 | 88 |
| Ex 24 | R-modified cellulose | 176.8 | 380 |
| Ex 25 | PVP K30 | 64.8 | 39.8 |
| Ex 26 | Protanal Sf 120RB | 51.66 | 283.6 |
| Ex 27 | Protanal Rf 5650 | 68.8 | 377 |
| Ex 28 | Gelcarin GP 812 | 90 | 336.2 |
| Ex 29 | Gelcarin GP 379 | 62 | 248 |
| Ex 30 | Silica | 321 | 374 |
| Ex 31 | Na carbonate light | 62 | 88 |
| Ex 32 | Kaolin | 42 | 37 |
| Ex 33 | Na carbonate coarse | 53 | 40 |
| Ex 34 | Macrosorb MS 15 | 105 | 120 |
| Ex 35 | Doucil A28 | 75 | 60 |
| Ex 36 | Macrosorb MS 33F | 81 | 82 |
| Reference | Talcum | 42 | 60 |

TABLE 4

| | | Water absorbtion |
|---|---|---|
| | Oil absorbtion (g/100 g) | (g/100 g) |
| Ex 37 | 57.8 | 212.5 |
| Ex 38 | 15.7 | 30.2 |
| Ex 39 | 58.2 | 39.8 |
| Ex 40 | 178.5 | 165.5 |
| Ex 41 | 55.5 | 252.5 |
| Ex 42 | 32.8 | 189.1 |
| Ex 43 | 40.1 | 266.0 |
| Ex 44 | 65.7 | 194.5 |
| Ex 45 | 61.1 | 219.5 |
| Ex 46 | 30.7 | 43.7 |
| Ex 47 | 30.3 | 52.3 |
| Ex 48 | 69.5 | 79.8 |
| Ex 49 | 57.8 | 69.6 |
| Ex 50 | 35.4 | 228.1 |
| Ex 51 | 34.4 | 227.0 |
| Ex 52 | 145.9 | 771.0 |
| Ex 53 | 88.5 | 781.9 |
| Reference | 42 | 60 |

Stain Removal Test

To test the effect of Examples 1 to 53 on oil-based stains, 0.1 grams of nut oil was applied directly on blue WFK cotton swatches. To test the effect of Examples 1 to 53 on water-based stains, 0.15 grams of tea and grape juice were applied on Tic 400 WFK cotton swatches. The stains were left for 10 minutes before cleaning.

In the cleaning process, 4 grams of the soil catcher powders of Examples 1 to 53 were used to treat the stain. The soiled areas were rubbed with a small sponge-in order to improve the contact between the stain and the powder. The powder was then left to work for 10 minutes and then brushed away with 5 scrubbing actions in the vertical direction and 5 in the horizontal direction.

The tea and grape juice stains were evaluated through a spectrophotometer, by measuring the reflectance values. The X Y Z scale was used with a spectrophotometer with the UV-filter at 460 nm. Y =90 means a complete stain removal (white cotton has a value of 90).

The nut oil stain on blue swatches was evaluated through panel test with a rating between I and 5. A rating of 1 was given in cases where the stain was completely removed. A rating of 5 was given in cases where the stain remained unchanged.

The ease with which the soil catcher powder could be removed from the swatches was also evaluated through panel test by using a rating from 0 to 4, where:

0=no residue

1=little residue

2=medium residue

3=medium/high residue

432 high residue (sticky)

The results are shown in the Tables below.

TABLE 5

| | | | | Grape | | | |
|---|---|---|---|---|---|---|---|
| | | Tea | | Juice | | oil | |
| | | removal | Residue | removal | Residue | removal | Residue |
| | Product name | (Y) | (rating) | (Y) | (rating) | (rating) | (rating) |
| Ex 1 | MICROSIL ED | 75.2 | 0 | 54.4 | 0 | 3.3 | 0 |
| Ex 2 | NEOSYL GP | 76 | 0 | 57.5 | 0 | 3 | 0 |
| Ex 3 | NEOSYL AC | 74.5 | 0 | 58.1 | 0 | 3.1 | 0 |
| Ex 4 | LUQUASORB MH 4055 | 68.7 | 0 | 60.8 | 0 | 3.7 | 1 |
| Ex 5 | ACUSOL 772 | 77.2 | 0 | 68.4 | 0 | 3.3 | 1 |
| Ex 6 | ALCOSORB AB3C | 66.9 | 3 | 58.8 | 3 | 3.2 | 2 |
| Ex 7 | ALCOSORB AB3S | 64 | 3 | 59.5 | 3 | 3.3 | 2 |
| Ex 8 | ALCOSORB G1 | 66.1 | 3 | 58.1 | 3 | 3.4 | 2 |
| Ex 9 | ALCOSORB G3 | 63 | 3 | 59.8 | 3 | 3.6 | 2 |
| Ex 10 | Laundrosil DGA | 72.6 | 0 | 59.5 | 0 | 4.2 | 2 |
| Ex 11 | Laundrosil 212 | 73.2 | 0 | 65.3 | 0 | 3.6 | 0 |
| Ex 12 | Laundrosil EX 0242 | 73.4 | 0 | 62.4 | 0 | 3.6 | 0 |
| Ex 13 | Dellite 67G | 61.2 | 0 | 59.9 | 0 | 3.4 | 2 |
| Ex 14 | Detercal P1 | 64.9 | 3 | 60.4 | 3 | 3 | 1 |
| Ex 15 | Cabloc C96 | 72 | 4 | 60.4 | 4 | 3.4 | 2 |
| Ex 16 | Cabloc CT | 68.1 | 4 | 57.3 | 4 | 3.4 | 2 |
| Ex 17 | Cabloc CTF | 69.2 | 4 | 58.6 | 4 | 3.4 | 2 |
| Ex 18 | Favor PAC 230 | 74.8 | 4 | 65.8 | 4 | 3.3 | 1 |
| Ex 19 | Zeolite 4A | 71.5 | 1 | 62.4 | 1 | 3.6 | 1 |
| Ex 20 | Disintex 75 | 74.2 | 1 | 60.2 | 1 | 3.6 | 2 |
| Ex 21 | Gypsum | 57.4 | 0 | 55.6 | 0 | 3.6 | 2 |
| Ex 22 | Chitosano 90% | 51.5 | 0 | 54.3 | 0 | 3.3 | 2 |
| Ex 23 | Laponite | 66.7 | 1 | 61.4 | 1 | 3.7 | 3 |
| Ex 24 | R-modified cellulose | 64.2 | 0 | 63.3 | 0 | 4 | 2 |
| Ex 25 | PVP K30 | 62.4 | 4 | 65.3 | 4 | 3 | 0 |
| Ex 26 | Protanal Sf 120RB | 65 | 4 | 65.8 | 4 | 3.4 | 2 |
| Ex 27 | Protanal Rf 5650 | 69.7 | 4 | 71 | 4 | 3.6 | 2 |
| Ex 28 | Gelcarin GP 812 | 65.9 | 0 | 68 | 0 | 3.4 | 1 |
| Ex 29 | Gelcarin GP 379 | 63.4 | 2 | 65.6 | 2 | 3.2 | 1 |
| Ex 30 | Silica | 66.2 | 2 | 67.2 | 2 | 3.5 | 2 |
| Ex 31 | Na carbonate light | 65.9 | 0 | 63 | 0 | 3.4 | 2 |
| Ex 32 | Kaolin | 62 | 1 | 49.7 | 1 | 3.4 | 2 |
| Ex 33 | Na carbonate coarse | 73 | 0 | 57.4 | 0 | 3.2 | 2 |
| Ex 34 | Macrosorb MS 15 | 71.4 | 0 | 58.6 | 0 | 3.4 | 4 |
| Ex 35 | Doucil A28 | 68.4 | 1 | 60.4 | 1 | 3.2 | 4 |
| Ex 36 | Macrosorb MS 33F | 66 | 1 | 60.2 | 1 | 3.5 | 4 |
| Reference | Talcum | 56.8 | 0 | 54 | 0 | 4.1 | 3 |

TABLE 6

| | | Grape Juice | oil removal |
|---|---|---|---|
| | Tea removal (Y) | removal (Y) | (rating) |
| Ex 37 | 60.5 | 57.5 | 3.7 |
| Ex 38 | 55.6 | 54.8 | 5 |
| Ex 39 | 70.1 | 59.5 | 4.5 |
| Ex 40 | 61.1 | 58.7 | 3.3 |
| Ex 41 | 63.6 | 62.4 | 3.7 |
| Ex 42 | 57.3 | 58.2 | 3.6 |
| Ex 43 | 67.4 | 61.4 | 4 |
| Ex 44 | 74.2 | 65.5 | 3.2 |
| Ex 45 | 69.8 | 64.2 | 3.2 |
| Ex 46 | 67.0 | 62.3 | 2.5 |
| Ex 47 | 58.5 | 66.9 | 2.8 |
| Ex 48 | 62.9 | 61.4 | 3.5 |
| Ex 49 | 71.5 | 64.9 | 4 |
| Ex 50 | 55.1 | 55.0 | 3.3 |
| Ex 51 | 65.5 | 59.3 | 3.5 |
| Ex 52 | 74.2 | 65.9 | 2 |
| Ex 53 | 61.2 | 62.2 | 3.3 |
| Reference | 56.8 | 54 | 4.1 |

1. A method for treating a laundry item, which comprises the steps of:
contacting the laundry item with a cleaning composition in the form of a solid comprising an insoluble active agent that is capable of binding soil, such that soil on the laundry item is bound to the insoluble active agent, and
removing the composition from the laundry item, optionally in the absence of water.

2. A method as claimed in claim 1, wherein the insoluble active agent is selected from at least one of acrylic polymer, polyester, polyvinylpyrrolidone (PVP), silica, silicate, zeolite, talc, bentonites, active carbon, alginates, carrageneans, ethylidene norbene/propylene/ethylidene ter-polymers and chitosan.

3. A method according to claim 1,
wherein the cleaning composition comprises less than 30% wt surfactant.

4. A method according to claim 1,
wherein surfactant is substantially absent from cleaning composition.

5. A laundry product having an enclosing wall and containing a composition in the form of a powder, said composition comprising an insoluble active agent which is capable of binding soil or free dyes, the wall being permeable to water and to components dissolved therein, wherein, after the product has been contacted with water in a laundry washing machine, the insoluble active agent remains within the enclosing wall.

6. A laundry product according to claim 5 wherein the composition also comprises a soluble laundry active agent selected from the group consisting of a surfactant, a bleach and a mixture thereof.

7. A laundry product according to claim 6 wherein the surfactant comprises an anionic or nonionic surfactant or a mixture thereof.

8. A laundry product according to claim 6 o wherein the bleach is an oxygen bleach.

9. A laundry product according to claim 8 wherein the bleach is percarbonate salt.

10. A laundry product according to claim 5, wherein, after the product has been subjected to a standard washing cycle in a laundry washing machine, from 5 to 80% wt of the composition remains.

11. A laundry product according to claim 5, wherein the insoluble active agent is selected from at least one of acrylic polymer, polyester, polyvinylpyrrolidone (PVP), silica, silicate, zeolite, talc, bentonites, active carbon, alginates, carrageneans and chitosan.

12. A laundry product according to claim 5 wherein the enclosing wall comprises a water-permeable, water-insoluble web.

13. A laundry product according to claim 5 wherein the enclosing wall has a roughened outer surface.

14. A laundry product according to claim 5 wherein the enclosing wall is a cellulosic material.

15. A laundry product according to claim 12 wherein the enclosing wall is a non-woven web.

16. A laundry product according to claim 12 wherein the wall is formed from a cellular plastics material, preferably selected from polyolefin, polyester or polyamide.

17. A laundry product according to claim 12 wherein the surface wall has been subjected to corona or plasma treatment or has been modified through chemical treatment.

18. A laundry product according to claim 5 wherein the enclosing wall is coated with a water-soluble component.

19. A laundry product according to claim 18 wherein the water-soluble component comprises a poly(vinyl alcohol).

20. A laundry product according to claim 5 wherein the enclosing wall comprises a portion formed of a water-permeable, water-insoluble material and another portion formed of a water impermeable wall.

21. A method of cleaning laundry in a laundry washing machine, which comprises adding a laundry product according to claim 5 to the washing machine and conducting the wash.

22. A method for cleaning a stain on a laundry item, which process comprises a process step selected from:
(a) contacting the stain directly with a laundry product as claimed in any one of claims 5 to 22 before the laundry item is washed, or
(b) adding a laundry product as claimed in any one of claims 5 to 20 directly into the drum of washing machine, or
(c) adding a laundry product as claimed in any one of claims 5 to 20 to a bucket with water and laundry and soaking for a predetermined length of time.
